(19) United States
(12) Patent Application Publication
(10) Pub. No.: US 2013/0098708 A1
(43) Pub. Date: Apr. 25, 2013

(54) Building Evacuation System

(71) Applicant: Antonio Garcia-Valdecasas Canet, Barcelona (ES)

(72) Inventor: Antonio Garcia-Valdecasas Canet, Barcelona (ES)

(21) Appl. No.: 13/283,677

(22) Filed: Oct. 28, 2011

(30) Foreign Application Priority Data
Oct. 19, 2011 (ES) P201101150

(51) Int. Cl. A62B 1/00

(52) U.S. Cl. 182/72

(57) ABSTRACT

This system comprises: support portions (11) fixed to the building corresponding to the different floors (P) of said building; a series of evacuation walkways (12) mounted onto these support portions (11), and which extend around at least a portion of the perimeter of the floors, fitted with several windows (V) or feasible exits; several stairways (13) and access ramps (14) fitted between consecutive floors (P); a protective outer surface (2) made up of a series of panels (21); at least a proportion of the panels (21) of the protective outer surface (2) will be made of breakable material in order to provide openings in the aforementioned outer surface (2) for exiting or jumping to the outside; and cabinets (4) containing parachutes for personal use, accessible from at least the evacuation walkways (12) that correspond to the higher floors of the building.

### FIELD OF THE INVENTION

The present invention relates to an evacuation system for buildings, particularly suited to the emergency evacuation of high-rise buildings.

This invention is applicable in the manufacture of passive security systems for buildings.

### BACKGROUND

At present, various devices used for the evacuation of persons from buildings in cases of emergency are known. These include emergency stairways which are attached to the outside of the building, and which are accessed from different floors through emergency exits at specific intervals.

These emergency stairways, as well as notoriously deteriorating the aesthetics of a building, bear the added drawback that the occupants of the building may not be able to access them. For example, in the case of a fire, the flames may block the passage to the emergency exits that lead to the stairs.

High-rise buildings such as those that the present invention is intended for, possess other security systems, such as automatic fire prevention facilities, or lifts that stop only on selected groups of floors in order to optimize use.

These systems present certain limitations, such as the need for an external supply of electricity or hydraulic pressure, which themselves may be rendered unusable for a variety of reasons, ranging from faults to fires or terrorist attacks.

Some other embodiments are also known in the state of the art that relate specifically to evacuation systems for buildings:

Document ES 2 257 212 B describes an evacuation system for high-rise buildings that consists of a habitable enclosure, connected to the building to which it belongs, and which can be accessed in a similar way to a balcony or veranda, and a container filled with helium adjacent to the habitable area. In case of emergency and the need to vacate the building, the habitable enclosure would serve as a cabin that would transport a certain number of persons. The helium body container would be filled with decompressed helium stored in bottles, pressure tanks or cryogenic tanks within the building, thereby increasing the volume of helium and allowing it to serve as a flotation body. The anchors that hold the whole assembly in place would then be released, allowing it to detach from the building and transfer to a clear space nearby.

Document PCT/ES2008/000704 describes a device for the fast evacuation of buildings, especially conceived for the evacuation and/or escape of persons, animals or objects from any level of any building, in the event that it should be necessary, for example in a fire, an earthquake, a terrorist attack or other situation of risk. The device of the invention comprises a spiral ramp, established between a central column and an external covering tube, the same height of the building in question, in such a way that the external tube is fitted with a series of lateral access openings that coincide in number and position with the floors of the building. In addition it has a door on the inside fitted with an anti-panic means of opening that facilitates the evacuation of the users.

These former embodiments, like fire stairways, have specific points of access which, in case of fire or partial detachment of walls or ceilings, may become inaccessible, resulting in the trapping of persons on the inside of the floors.

Another drawback is their limited capacity of evacuation.

### SUMMARY

The evacuation system for buildings object of this invention is of the type that consists of an external structure fixed onto the building façade, fitted with a set of evacuation stairs situated between the levels corresponding to consecutive floors. The invention presents a series of characteristics intended to allow access to the building from different floors of the building, through several windows or feasible openings on each floor, allowing the occupants of each floor to access the evacuation system even if part of the relevant floor or floors is blocked or inaccessible.

A further object of the invention is to allow the evacuation on foot of persons with or without disabilities, by means of exterior walkways set out on the façade of the building in question, corresponding to the different floors of the building, and a series of stairways and access ramps conveniently distributed between the walkways of consecutive floors.

In addition, the ramps may have an autonomous system installed for the raising/lowering of persons with disabilities.

A further object of the invention is to provide the evacuation system with a protective outer surface that, in conjunction with the building façade, would delimitate the evacuation zone, in order to avoid persons accidentally falling out to the ground. The aforementioned protective outer surface would consist of a series of panels mounted on a supporting structure; at least some of the panels would be made of a breakable material that would provide openings for exiting or jumping to the outside.

A still further object of the invention is to provide the system with storage spaces for parachutes for personal use, located in those floors of the building that are sufficiently high so that the parachute would be able to open during the fall.

According to the invention and in order to achieve the proposed goals this system comprises: support portions fixed onto the building and corresponding to the different floors of said building; evacuation walkways mounted onto the aforementioned support portions, which extend around at least a part of the perimeter of the floors and which are fitted with several windows or feasible exits that allow access to the evacuation walkways; several stairways and access ramps set out between the evacuation walkways that correspond to the consecutive floors of the building; a protective outer surface consisting of a series of panels mounted onto a support structure that, in conjunction with the building façade, delimitates the evacuation zone in which the evacuation walkways, stairways and access ramps are situated; the provision that at least some of the panels on the protective outer surface will be made of a breakable material that will provide, through selective breakage, openings that enable people to exit or jump to the outside; cabinets containing parachutes for personal use that will be accessible from at least the evacuation walkways that correspond to the higher floors of the building.

In addition to the exits via the walkways, shuttles may be installed in the roof of the building.

The supply of the aforementioned parachutes on the higher floors, located at sufficient height so that the parachute may open during the fall and therefore be effective, for example at higher than 50 metres, provides the habitual occupants of these floors with a valid means of evacuation, in order to save lives when no other escape route is possible.

By breaking selected panels of the protective outer surface, which can be marked for this purpose, the parachute users have at their disposal a series of openings from which to jump.

The invention anticipates that the panels that make up the protective outer surface will ideally be made of transparent or translucent materials, in order to let natural light enter the inside of the building.

The cabinets containing the parachutes may be provided in different locations, ideally built into the building façade, with an access door oriented toward the evacuation walkways, so that they might be accessible to the persons using the walkways.

Furthermore, the cabinets containing the parachutes on the outside of the building façade should be fixed to the support portions of the structure.

According to the invention, the panels that form the protective outer surface will be fixed by means of clamps onto vertical tubes, which will in turn be fixed onto the support portions of the structure, thereby allowing the individual breakage of selected panels in order to create the openings in the protective outer surface for exiting or jumping out.

### DESCRIPTION OF THE DRAWINGS

By way of complementing the present description, and with the aim of facilitating understanding of the characteristics of the invention, this descriptive summary is accompanied by a set of drawings which include, but are not limited to, the following features:

FIG. 1 is a schematic front elevation view of an example embodiment of the evacuation system for buildings as according to the invention, which shows the access stairways set out between the walkways on consecutive floors.

FIG. 2 is the same elevation view as the previous drawing, showing the access ramps set out between the walkways on consecutive floors.

FIG. 3 is a schematic front elevation view of a section of the evacuation system corresponding to FIG. 1, in which only three of the protective outer surface's columns of panels are shown, and in which a possible provision of access stairways between the walkways of consecutive floors can be seen.

FIG. 4 is a schematic front elevation view of a section of the evacuation system corresponding to FIG. 2, in which the provision of access stairways between walkways of consecutive floors can be seen.

### DETAILED DESCRIPTION

In the example embodiment shown in the attached drawings the building evacuation system consists of an structure (1) fixed externally onto the façade (F) of a building, fitted with support portions (11) fixed onto the building and corresponding to the different floors (P) of that building. Mounted onto these support portions (11) there are evacuation walkways (12), accessible from several windows (V) or feasible exits on each floor (P).

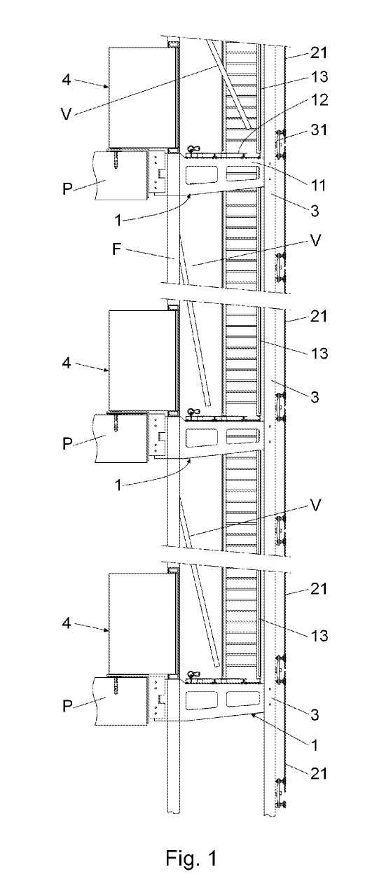

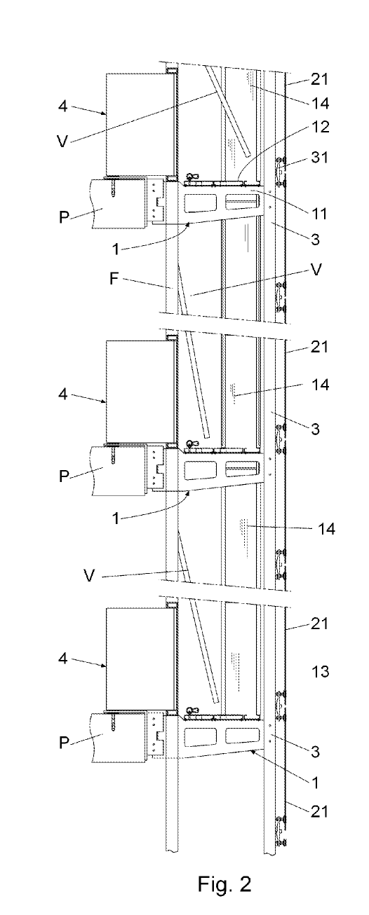

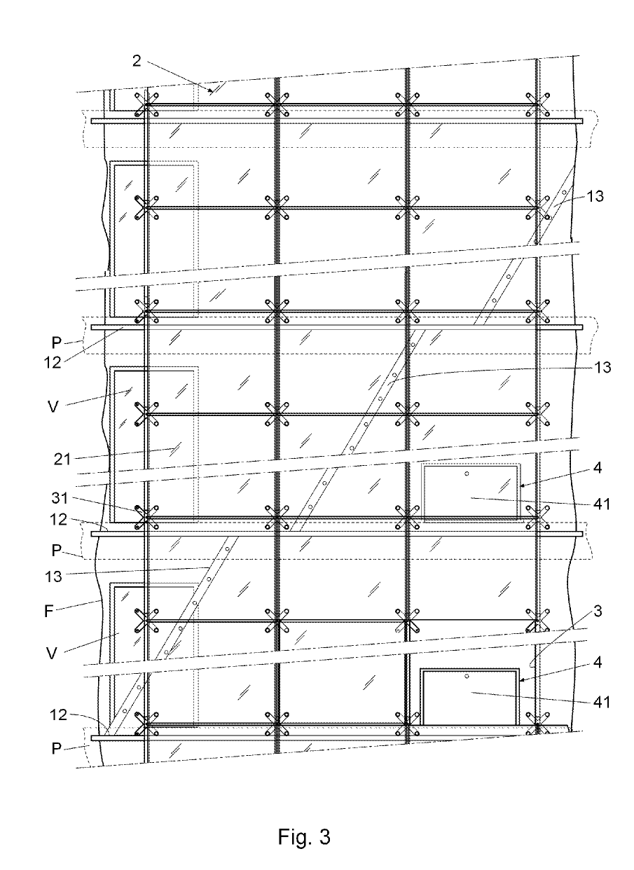

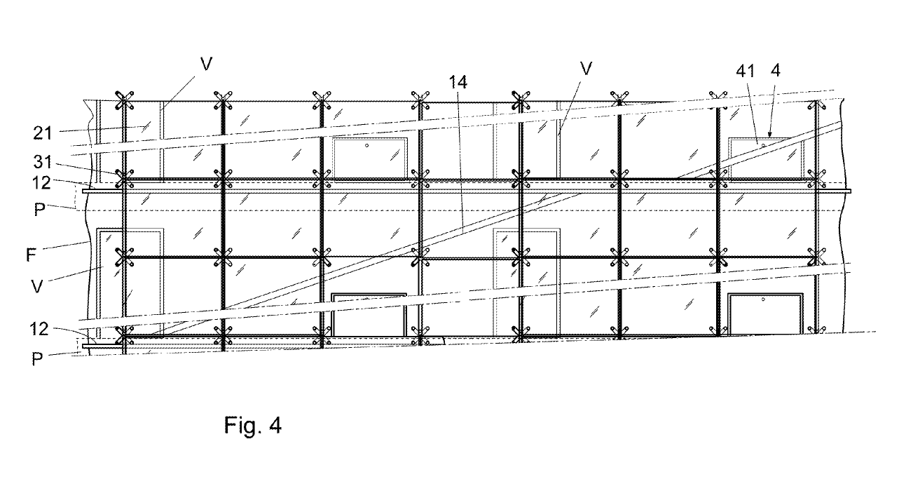

The evacuation walkways (12) corresponding to consecutive floors (P) are communicated by means of access stairways (13) shown in FIGS. 1 and 3, and by access ramps (14) shown in FIGS. 2 and 4.

In the example given the system consists of a protective outer surface (2), made up of multiple panels (21), in this case of transparent glass, fixed by means of clamps(31) onto vertical tubes (3), which in turn are fixed onto the support portions (11) of the structure (1).

The aforementioned protective outer surface (2) delimitates, in conjunction with the façade (F), the evacuation zone in which the walkways (12), stairways (13) and access ramps (14) are situated.

On the higher floors of the building the system provides cabinets (4) containing parachutes for personal use, accessible from the evacuation walkways (12).

In the example given these cabinets (4) are built into the building façade (F), and are provided of an access door (41) oriented toward the evacuation walkways (12).

The selective breaking of certain panels (21) of the protective outer surface (2) will create a series of openings from which persons equipped with parachutes may jump.

Although the present invention has been described, as an example of a given preferred embodiment, for the record and for relevant purposes, the materials, form, size and provision of the described elements may be modified, whenever this does not suppose an alteration of the essential characteristics of the invention, which are claimed as follows.

1. Evacuation system for buildings, preferably applicable and especially indicated for the emergency evacuation of high-rise buildings; of the type that includes an external structure (1) fixed onto the building façade (F), fitted with a set of access stairs (13) situated between the levels corresponding to consecutive floors (P); wherein the evacuation system comprises: support portions (11) fixed to the building corresponding to the different floors (P) of said building; a series of evacuation walkways (12) mounted on the aforementioned support portions (11), and which extend around at least a portion of the perimeter of the floors, fitted with several windows (V) or feasible exits to allow access to the aforementioned evacuation walkways (12); several stairways (13) and access ramps (14) fitted between each pair of consecutive floors (P); a protective outer surface (2) made up of a series of panels (21) mounted on the support structure (1), which delimitate, in conjunction with the building façade (F) an evacuation zone in which both the evacuation walkways (12), the stairways (13) and access ramps (14) are situated; at least a part of the panels (21) of the protective outer surface (2) being made of breakable material in order to provide openings in said surface for exiting or jumping to the outside; having as well some cabinets (4) containing parachutes for personal use will be accessible from at least the evacuation walkways (12) that correspond to the higher floors of the building.

2. System according to claim 1, wherein the panels (21) of the protective outer surface (2) are made of transparent or translucent materials

3. System according to claim 1, wherein the cabinets (4) containing parachutes are built into the building façade and are provided with access doors (41) oriented toward the evacuation walkways (12).

4. System according to claim 1, wherein the cabinets (4) containing parachutes are fixed to the support portions (11) of the structure.

5. System according to claim 1, wherein the panels (21) that form the protective outer surface (2) are fixed by means of clamps (31) to vertical tubes (3) which are in turn fixed to the support portions (11) of the structure (1).
